(19) United States
(12) Patent Application Publication
(10) Pub. No.: US 2024/0247113 A1
(43) Pub. Date: Jul. 25, 2024

(54) METHOD OF FORMING AN AQUEOUS POLYMER COMPOSITION

(71) Applicant: Applied Materials, Inc., Santa Clara, CA (US)

(72) Inventor: Joseph Cameron BYERS, Kalispell, MT (US)

(21) Appl. No.: 18/100,568

(22) Filed: Jan. 23, 2023

(51) Int. Cl. C08J 3/21

(52) U.S. Cl. CPC C08J 3/21; C08J 2387/00; C08J 2487/00

(57) ABSTRACT

Embodiments of the disclosure relate to a substrate etching system and process. A method may include generating a first solution comprising a first polymer resin and a second polymer resin, receiving a second solution comprising the first polymer resin and a third solution comprising the second polymer resin, assessing a viscosity of the first solution, and adjusting the viscosity using the second solution and the third solution according to a downstream viscosity range.

### BACKGROUND

### Field of the Invention

Embodiments of the invention generally relate to compositions and methods for forming aqueous polymers used as thin film polymers during a process of forming semiconductor devices.

### Description of the Related Art

In semiconductor wafer processing, integrated circuits are formed on a wafer (also referred to as a substrate) composed of silicon or other semiconductor material. In general, layers of various materials are utilized to form the integrated circuits. These materials are doped, deposited and etched using various well-known processes to form integrated circuits. Each wafer is processed to form a large number of individual regions containing integrated circuits known as dies.

Following the integrated circuit formation process, the wafer is “diced” to separate the individual die from one another for packaging or for use in an unpackaged form within larger circuits. A main technology used for wafer dicing are is plasma etching. Plasma etching utilizes plasma etch reactors for etching trenches in desired regions of a semiconductor substrate, such as the regions disposed between formed die, which are often referred to as the “street” regions. These reactors contain a chamber within which the substrate is supported. At least one reactive gas is supplied to the chamber and a radio frequency signal is coupled to the reactive gas to form the plasma. The plasma etches the substrate that is positioned within the reactor producing a “trench profile” within the desired regions of a substrate.

These trench profiles are complicated by the materials being etched and the type of etching system being used. Some materials of particular importance include silicon, metals, oxides, and thin film polymers. Indeed, the thin film polymer layer is of critical importance because it protects the semiconductor substrate during plasma etch, due to silicon mask etch selectivity, allowing deep trenching into the Si substrate. A thin film polymer that is too thin will result in trench sidewalls degrading, while a thin film polymer that is too thick will prevent the etching process, which often includes laser scribing, from removing the thick polymer material layer all the way through. Viscosity and other characteristics of the thin film polymer will directly impact coating thickness, uniformity, and on-tool performance. As such, viscosity must be regulated during manufacturing. Unfortunately, the viscosity of the thin film polymer layer protecting the semiconductor substrate is challenging to regulate during manufacturing, and inconsistencies make the process of depositing a repeatable and uniform thin polymer layer difficult.

Generally, these thin film polymers are produced using a pass down approach which lowers end-product viscosity thru water dilution. This approach requires the first step of production—the water-based polymer—to be produced within a narrow range of viscosity, in order to fall within desired downstream viscosity ranges. Deviations from these narrow ranges result in non-manufacturability of end product, e.g., when viscosity is low. The Pass down approach undesirably introduces variable concentrations of functional additives, dependent on polymer viscosity.

Indeed, chemical suppliers of polymer resins produce inherently variable specifications in lot-to-lot batch production. This leads to different results in viscosity and thin film thicknesses because blending two polymer resin grades at a particular ratio will have different results, depending on lot average molecular weight, and manufacturing parameters. As such, there is a need to monitor and adjust resin ratios lot to lot in order to maintain batch to batch viscosity consistency of the aqueous solution produced for the thin film polymer of semiconductor wafers.

Therefore, there is a need for an improved method of targeting viscosity in aqueous polymer matrices for controlling the thickness and uniformity of the thin polymer film and subsequently, the amount of protection against etching of a substrate formed therein.

### SUMMARY

Embodiments of the disclosure provided herein generally relate to compositions and methods for aqueous polymers used as thin film polymers for substrate etching. In one aspect, of the disclosure provided herein relates to an improved method of forming an aqueous polymer composition in aqueous polymer matrices, which includes producing a first solution comprising a first polymer resin, and a second solution comprising a second polymer resin, generating a third solution by mixing the first polymer resin and the second polymer resin, assessing a viscosity of the third solution, and adjusting the viscosity using the first solution and the second solution according to a downstream viscosity range.

In another aspect, the embodiments of the disclosure provided herein relate to an aqueous polymer composition for a wafer singulation, in which the aqueous polymer composition includes a water soluble composition comprising a first polymer resin, a second polymer resin, and water, and an aqueous additive solution comprising laser scribe and/or plasma etch performance enhancing chemicals, e.g. a nanoparticle, a light absorbing dye, a biocide, and a surfactant.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a method of targeting a viscosity of a polymer composition, according to one or more embodiments.

FIG. 1B illustrates a method of mixing an additive solution, according to one or more embodiments.

FIG. 2A illustrates a range of potential polymer compositions that can be formed using methods disclosed herein, according to one or more embodiments.

FIG. 2B illustrates an example of processes for generating differing polymer compositions within a tunable viscosity range, according to one or more embodiments.

FIGS. 3A1 and 3A2 each illustrate portions of a method of forming a mid-viscosity aqueous polymer composition, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Various embodiments, versions of the disclosed compounds, processes, and articles of manufacture, will now be described, including specific embodiments and definitions that are adopted herein. While the following detailed description gives specific embodiments, those skilled in the art should appreciate that these embodiments are exemplary only, and that embodiments of the present disclosure can be practiced in other ways. Any reference to embodiments may refer to one or more, but not necessarily all, of the compounds, processes, or articles of manufacture defined by the claims. The use of headings is for purposes of convenience only and does not limit the scope of the present disclosure.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, “in a range” or “within a range” includes every point or individual value between its end points even though not explicitly recited and includes the end points themselves. Thus, every point or individual value may serve as its own lower or upper limit combined with any other point or individual value or any other lower or upper limit, to recite a range not explicitly recited.

Embodiments of the disclosure provided herein generally relate to compositions and methods for forming aqueous polymers used as thin film polymers during a process of forming semiconductor devices. As set forth herein, aspects of the disclosure provided herein relate to a semiconductor device manufacturing system and semiconductor device manufacturing processes. In some embodiments, the disclosure provided herein relates to dicing process that includes the use of silicon etching process. It is to be noted, however, that aspects of the disclosure provided herein are not limited to use with silicon etching, but are applicable to etching other types of materials used in semiconductor device manufacturing. To better understand the novelty of the compositions within the present disclosure and the methods of use thereof, reference is hereafter made to the accompanying drawings.

A composition and method for manufacturing aqueous polymers used as plasma etch resist (PR) thin film polymers for etching a deep trench in a silicon substrate having oxide and metal layers disposed on the substrate is provided. The method provides a practical application of addressing chemical supplier lot variations, allowing the manufacture of an end-chemistry adhering to viscosity specifications, through a parallel manufacturing process using two grades of polymer raw material. The method and compositions allow technicians to calculate blend ratios within a desired downstream viscosity range of the two grades of raw polymer resin using the Arrhenius logarithmic binary mixing equation. The new methods described herein have a high tunability and produce a very low scrap rate.

Overall, the methods and matrices provided widen upstream specifications, reduce scrap-rate, and offer precise viscosity control of aqueous polymer matrices. Viscosity control allows for uniform and repeatable thin film thicknesses to be achieved during processing which will reduce material waste while also concurrently assuring a desirable level of protection against during the etching process performed on a substrate during a dicing process. By adapting the Arrhenius binary logarithmic mixing equation to ideal aqueous polymer chemistry blending, and selecting the two appropriate grades of polymer resin, a targeted viscosity specification may be obtained anywhere within the range capabilities of the two resins and the end chemistry. As such the methods and compositions described herein reduce or altogether remove the amount of waste and theoretically allows an infinite feedback loop capable of precisely targeting a final-good viscosity for the aqueous polymer composition product that can be used in a subsequent semiconductor device fabrication process. Additionally, other parameters including percent solid, additive concentration, and the like may be targeted and achieved, effectively shifting the viscosity range capability of the mixture up or down, and providing for a wider range of end-product specifications, obtainable from the same raw materials, while still allowing an infinite feedback loop to control the final viscosity of the polymer composition within a desired range.

### Aqueous Polymer Solutions

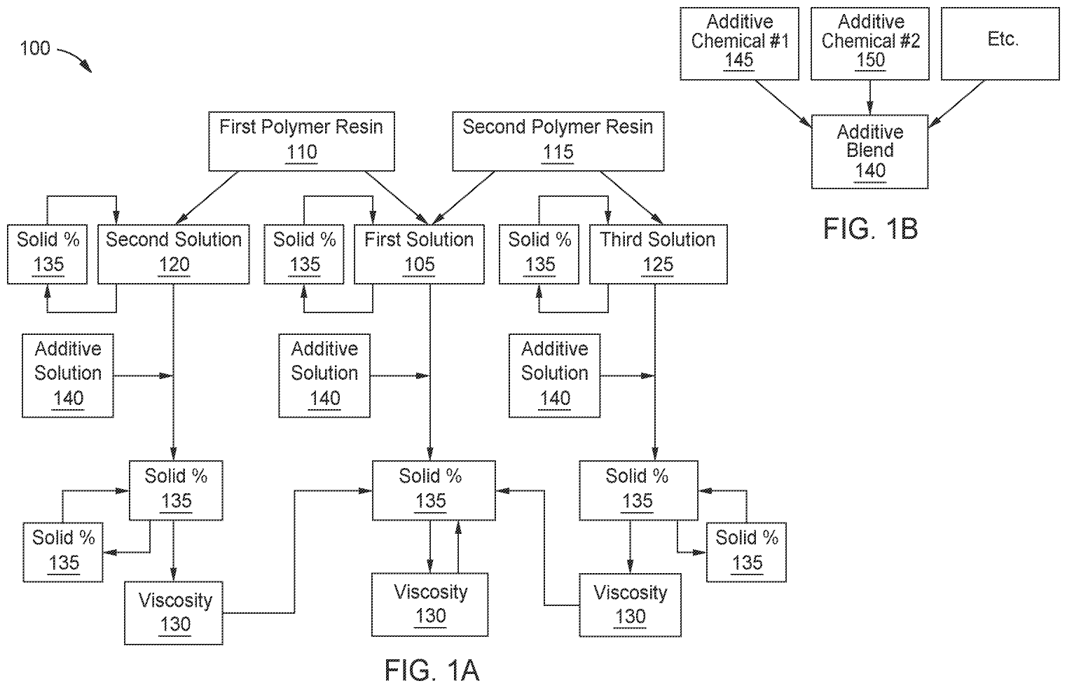

In an embodiment, as shown in FIG. 1A, a method 100 of forming an aqueous polymer composition is provided. The method 100 includes generating a first solution 105 by mixing a first polymer resin 110 and a second polymer resin 115. In some embodiments, each of the first polymer resin 110 and the second polymer resin 115 are independently selected from the group consisting of poly(vinyl alcohol), poly(vinyl pyrrolidone), poly(acrylic acid), poly(methacrylic acid), poly(acrylamide) and poly(ethylene oxide), poly(ethylene glycol), poly(2-ethyl-2-oxazoline), polystyrene-maleic acid copolymer, hydroxyethyl cellulose and hydroxyethyl starch.

In some embodiments, each of the first polymer resin 110 and the second polymer resin 115 are independently a low molecular weight resin, e.g., a resin having a molecular weight of less than or equal to 100,000 da, e.g., about 1,000 da, about 2,000 da, about 3,000 da, about 4,000 da, about 5,000 da, about 6,000 da, about 7,000 da, about 8,000 da, about 9,000 da, about 10,000 da, about 15,000 da, about 20,000 da, about 25,000 da, about 30,000 da, about 40,000 da, about 50,000 da, about 60,000 da, about 70,000 da, about 80,000 da, about 90,000 da, about 100,000 da, or the like. In some embodiments, each of the first polymer resin 110 and the second polymer resin 115 are independently a high molecular weight resin, e.g., a resin having a molecular weight of greater than 100,000 da, e.g., about 100,001 da, about 110,000 da, about 120,000 da, about 130,000 da, about 140,000 da, about 150,000 da, about 200,000 da, about 250,000 da, about 300,000 da, about 350,000 da, about 400,000 da, about 450,000 da, about 500,000 da, about 550,000 da, about 600,000 da, about 650,000 da, about 700,000 da, about 750,000 da, about 800,000 da, about 850,000 da, about 900,000 da, about 950,000 da, about 1,000,000 da, greater than 1,000,000, or the like.

In some embodiments, each of the first polymer resin 110 and the second polymer resin 115 are independently are readily dissolvable in an aqueous media. In some embodiments, each of the first polymer resin 110 and the second polymer resin 115 are independently may be composed of a material that is soluble in one or more of an alkaline solution, an acidic solution, or in deionized water. In some embodiments, each of the first polymer resin 110 and the second polymer resin 115 are independently may be soluble in polar organic solvents, such as isopropyl alcohol.

In some embodiments, the first polymer resin 110 is a low molecular weight resin, and the second polymer resin 115 is a high molecular weight resin. In some embodiments, the first polymer resin 110 is a high molecular weight resin, and the second polymer resin 115 is a low molecular weight resin. In some embodiments, the first polymer resin 110 is a low molecular weight resin, and the second polymer resin 115 is a low molecular weight resin. In some embodiments, the first polymer resin 110 is a high molecular weight resin, and the second polymer resin 115 is a high molecular weight resin.

In one embodiment, the first solution 105 is a PVA-based water-soluble composition, in which the PVA is the solid component from both the first polymer resin 110 and the second polymer resin 115. In some embodiments, the first solution 105 is a mixture water-soluble resins, in which the first polymer resin 110 is a first water soluble resin and the second polymer resin 115 is a second water soluble resin.

In some embodiments, the first solution 105 has a low viscosity, mid viscosity, or high viscosity based on the first polymer resin 110 and the second polymer resin 115. For example, the first solution 105 may have a low viscosity when the first polymer resin 110 is a low molecular weight resin and the second polymer resin 115 is a low molecular weight resin. As a further non-limiting example, the first solution 105 may have a mid-viscosity when the first polymer resin 110 is a low molecular weight resin and the second polymer resin 115 is a high molecular weight resin. As a further non-limiting example, the first solution 105 may have a mid-viscosity when the first polymer resin 110 is a high molecular weight resin and the second polymer resin 115 is a low molecular weight resin. As a further non-limiting example, the first solution 105 may have a high-viscosity when the first polymer resin 110 is a high molecular weight resin and the second polymer resin 115 is a high molecular weight resin.

In an embodiment, and still referring to FIG. 1A, the method 100 of forming an aqueous polymer composition includes receiving a second solution 120 having the first polymer resin 110. In one embodiment, the second solution 120 is a polyvinyl alcohol (PVA)-based water-soluble composition, where the PVA is the solid component. In another embodiment, as shown in FIG. 1A, the method 100 includes receiving a third solution 125 having the second polymer resin 115. In one embodiment, the third solution 125 is a polyvinyl alcohol (PVA)-based water-soluble composition, where the PVA is the solid component.

### Viscosity

In some embodiments, as shown in FIG. 1A, the method 100 includes assessing the viscosity of the first solution 105, second solution 120, and/or the third solution 125. Viscosity is a measure of a substance's resistance to motion under an applied force, in which a shear stress, e.g., force per unit area required to move on layer of fluid in relation to another, is divided by a shear rate, e.g., change in speed at which intermediate layers move with respect to one another. In some embodiments, viscosity is measured according to a viscometer. The viscometer may include any appropriate viscometer for identifying the dynamic or kinematic viscometer. For example, the viscometer may include a U-tube viscometer, a falling-sphere viscometer, a falling-ball viscometer, a falling-piston viscometer, an oscillating-piston viscometer, a vibrational viscometer, a rotational viscometer, a bubble viscometer, a rectangular-slit viscometer, a Krebs viscometer, or the like. For example, a rotational viscosity method may be utilized, e.g., degas the solution, stabilize the temperature, and analyze viscosity.

In some embodiments, the first solution 105 may have a range of viscosities according to the amount of the first polymer resin 110 and the amount of the second polymer resin 115 added. For example, the first solution 105 may have a viscosity at room temperature ranging from about 100 cP to about 20,000 cP, e.g., about 100 cP, about 200 cP, about 300 cP, about 400 cP, about 500 cP, about 600 cP, about 700 cP, about 800 cP, about 900 cP, about 1,000 cP, about 1,100 cP, about 1,200 cP, about 1,300 cP, about 1,400 cP, about 1,500 cP, about 1,600 cP, about 1,700 cP, about 1,800 cP, about 1,900 cP, about 2,000 cP, about 2,100 cP, about 2,200 cP, about 2,300 cP, about 2,400 cP, , about 2,500 cP, about 2,600 cP, about 2,700 cP, about 2,800 cP, about 2,900 cP, about 3,000 cP, about 4,000 cP, about 5,000 cP, about 7,500 cP, about 10,000 cP, about 15,000 cP, about 20,000 cP, or the like.

In some embodiments, the second solution 120 is made from the first polymer resin 110 having a low molecular weight resin, resulting in a low viscosity, e.g., having a viscosity ranging from about 100 cP to about 5,000 cP at room temperature, e.g., about 100 cP, about 200 cP, about 300 cP, about 400 cP, about 500 cP, about 600 cP, about 700 cP, about 800 cP, about 900 cP, about 1,000 cP, about 1,100 cP, about 1,200 cP, about 1,300 cP, about 1,400 cP, about 1,500 cP, about 1,600 cP, about 1,700 cP, about 1,800 cP, about 1,900 cP, about 2,000 cP, about 2,100 cP, about 2,200 cP, about 2,300 cP, about 3,000 cP, about 4,000 cP, or about 5,000 cP. In other embodiments, the second solution 120 is made from a first polymer resin 110 having a high molecular weight resin, resulting in a high viscosity, e.g., a viscosity ranging from about 5,000 cP to about 20,000 cP at room temperature, e.g., about 5,000 cP, about 10,000 cP, about 15,000 cP, or about 20,000 cP.

In some embodiments, the third solution 125 is made from the second polymer resin 115 having a low molecular weight resin, resulting in a low viscosity, e.g., a viscosity ranging from about 100 cP to about 5,000 cP at room temperature, e.g., about 100 cP, about 200 cP, about 300 cP, about 400 cP, about 500 cP, about 600 cP, about 700 cP, about 800 cP, about 900 cP, about 1,000 cP, about 1,100 cP, about 1,200 cP, about 1,300 cP, about 1,400 cP, about 1,500 cP, about 1,600 cP, about 1,700 cP, about 1,800 cP, about 1,900 cP, about 2,000 cP, about 2,100 cP, about 2,200 cP, about 2,300 cP, about 3,000 cP, about 4,000 cP, or about 5,000 cP. In other embodiments, the third solution 125 is made from a second polymer resin 115 having a high molecular weight resin, resulting in a high viscosity, e.g., a viscosity ranging from about 5,000 cP to about 20,000 cP at room temperature, e.g., about 5,000 cP, about 10,000 cP, about 15,000 cP, or about 20,000 cP.

In some embodiments, a viscosity 130 of the first solution 105 is assessed, in which the viscosity may be adjusted according to a downstream viscosity range. A “downstream viscosity range,” as used herein, is a viscosity range that the first solution, second solution, or third solution may be such that the first solution 105 will generate a thin film coating within a predetermined thickness. In some embodiments, downstream viscosity range may be movable within the same choice of raw materials based on ratio and solid content. For example, a downstream viscosity range may include a range of viscosities from about 500 cP to about 5,000 cP at room temperature, e.g., about 500 cP, about 600 cP, about 700 cP, about 800 cP, about 900 cP, about 1000 cP, about 1,250 cP, about 1,500 cP, about 2,000 cP, about 2,500 cP, about 3,000 cP, about 4,000 cP, about 5,000 cP. A specific final product may have a narrow downstream range depending on application and chemical properties. For example, a final viscosity specification may include a target of 3,000 cP +/−150 cP at room temperature, or the like.

In some embodiments, the viscosity may be adjusted using the second solution 120 or the third solution 125. For example, an assessed viscosity 130 that is too high, e.g., exceeds the downstream viscosity range, may be adjusted by mixing a lower viscosity solution to reduce the viscosity of the first solution 105. As a further non-limiting example, an assessed viscosity 130 that is too low, e.g., is below the downstream viscosity range, may be adjusted by mixing a higher viscosity solution to reduce the viscosity of the first solution 105. In some embodiments, the viscosity may be adjusted using the second solution 120 or the third solution 125 until the viscosity of the first solution 105 is within the downstream viscosity range.

In some embodiments, the viscosity 130 of the first solution 105 may be adjusted the second solution 120 or the third solution 125 such that the thin film polymer formed from the first solution 105 has a thickness of about 5 to about 30 μm, e.g., about 5 μm, about 10 μm, about 15 μm, about 20 μm, about 25 μm, or about 30 μm. The thin film polymer may be formed according to any of the baking, spin coating, or spray coating procedures described herein.

### Solid Percent (%)

In some embodiments, as shown in FIG. 1A, the method 100 includes assessing the weight percent of the solid component (solid %) 135 of the first solution 105, second solution 120, and/or the third solution 125. The solid % 135 of the first solution 105, second solution 120, and/or third solution 125 may be within a predetermined range, e.g. about 5-50 solid %, e.g., about 10% to about 40%, e.g., about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, or the like. In some embodiments, solid % 135 is measured according to a refractive index and/or a moisture balance/analyzer.

In one embodiment, the first solution 105 may be produced and a solid % 135 of the first solution 105 may be assessed. In some embodiments, a solid % 135 of the first solution 105 that is not within a first predetermined range may be adjusted by adding the first polymer resin 110, the second polymer resin 115, and/or water. In other embodiments, solid % 135 of the first solution 105 that is not within a first predetermined range may be adjusted by adding the second solution 120 and/or the third solution 125. In other embodiments, solid % 135 of the first solution 105 that is not within a first predetermined range may be adjusted by adding water, and/or heating the solution to evaporate water. For example, a bench-top lab heating mantle, for small scale reactions, may be used to head the solution to evaporate water. Alternatively, a jacketed reaction vessel may be utilized.

In one embodiment, the first predetermined range many include any of the predetermined range described herein. For example, the first predetermined range may include a range of about 10-40 solid %, e.g., about 10-30 solid %, about 15-40 solid %, about 20-30 solid %, or the like.

In one embodiment, the second solution 120 may be produced and a solid % 135 of the second solution 120 may be assessed. A solid % 135 of the second solution 120 that is not within a second predetermined range may be adjusted by adding the first polymer resin 110, and/or water. In one embodiment, the second predetermined range many include any of the predetermined range described herein. For example, the second predetermined range may include a range of about 10-40 solid %, e.g., about 10-30 solid %, about 15-40 solid %, about 20-30 solid %, or the like.

In one embodiment, the third solution 125 may be produced and a solid % 135 of the third solution 125 may be assessed. A solid % 135 of the third solution 125 that is not within a third predetermined range may be adjusted by adding the second polymer resin 115 and/or water. In one embodiment, the third predetermined range many include any of the predetermined range described herein. For example, the third predetermined range may include a range of about 10-40 solid %, e.g., about 10-30 solid %, about 15-40 solid %, about 20-30 solid %, or the like.

In some embodiments, the predetermined percent solid range of each first, second, and third solutions may be the same to ensure ideal mixing between the solutions, and predictive capability. In some embodiments, the first predetermined range is 20%, the second predetermined range is 20%, and the third predetermined range is 20% to ensure ideal binary mixture occurs. In some embodiments, the first predetermined range, the second predetermined range, and the third predetermined range may be different.

### Additives

In an embodiment, as shown in FIG. 1B, a method 100 of forming an aqueous polymer composition includes mixing an additive solution 140 with the first solution, the second solution, and the third solution. The additive solution 140 includes one or more chemicals or compounds to assist with substrate etching process or generating a desired viscosity. In some embodiments, the additive solution 140 includes a first additive chemical 145. In some embodiments, the additive solution includes a second additive chemical 150. In some embodiments, the additive solution includes a third additive chemical The aqueous additive solution may include one or more chemicals or compounds capable of enhancing performance, e.g. substrate adhesion/removal, plasma etch resistance, laser engagement, product stability, spin/spray coat uniformity, or the like. The additive chemical may include one or more chemicals or compounds capable of enhancing plasma etch selectivity, e.g., a metallic nanoparticle, a light absorbing dye, a biocide, a surfactant, a buffer, water, an aqueous additive blend compatible with polymer, or the like. For example, the additive solution 140 may include a metallic nanoparticle. In some embodiments, the metallic nanoparticle is a metal that cannot be etched by fluorine, e.g., aluminum, tin copper, nickel, silver, or chromium. In some embodiments, the metallic nanoparticle is a p-block metal compound, an s-block metal compound, or a transition metal compound. In one embodiment, the p-block metal compound includes an aluminum cation or a tin cation. In one embodiment, the s-block metal compound includes a potassium cation or a calcium cation. In one embodiment, the transition metal compound includes a copper cation, a nickel cation, a silver cation, or a chromium cation. In one embodiment, the p-block metal compound, the s-block metal compound, or the transition metal compound includes an acetate anion. In some embodiments, the metallic nanoparticle may include aluminum acetate.

In some embodiments, the additive solution 140 includes one or more chemicals or compounds for laser engagement during at least portion of the etching process. For example, the additive solution 140 may include a light absorbing dye. In some embodiments, the light absorbing dye is capable of absorbing light from an electromagnetic wave, e.g., radio waves, microwaves, infrared radiation, visible light, ultraviolet radiation, X-rays, or Gamma rays. In some embodiments, the light absorbing dye is capable of absorbing light from an electromagnetic wave having a wavelength of about 50 nm to about 900 nm, e.g., about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, or the like. In some embodiments, the light absorbing dye is a UV/Vis absorbing dye.

In some embodiments, the additive solution 140 includes one or more chemicals or compounds for fungal or bacterial inhibition. For example, the additive solution 140 may include a biocide. In some embodiments, the biocide may include one or more of a fungicide, herbicide, insecticide, algaecide, molluscicide, mitigicde, piscicide, rodenticide, slimicide, germicide, antibiotic, antibacterial, antiviral, antifungal, antiprotozoal, antiparasitic, or the like.

In some embodiments, the additive solution 140 includes one or more chemicals or compounds for emulsification of non-water soluble additives. For example, the additive solution 140 may include a surfactant. In some embodiments, the surfactant may include an ionic surfactant or a non-ionic surfactant. For example, the surfactant may include an anionic surfactant, nonionic surfactant, cationic surfactant, amphoteric surfactant, or the like.

In some embodiments, the additive solution 140 includes one or more chemicals or compounds for adjusting or buffering pH. For example, the additive solution 140 may include a buffer. In some embodiments, the buffer includes an amine.

In some embodiments, the additive solution 140 may further include other additives, such as adhesion promotors, defoamers, or corrosion inhibitors.

### Composition Range

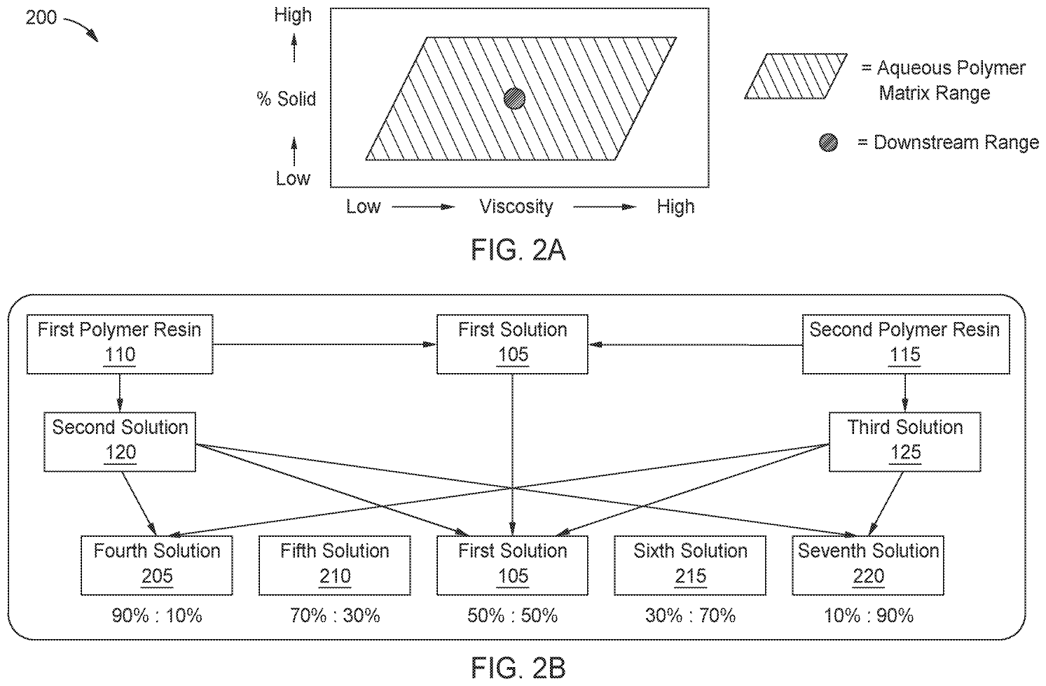

In some embodiments, as shown in FIG. 2A, the method 100 includes producing a composition range 200 including a viscosity range and a solid % range of an aqueous polymer composition. A viscosity range may include any of the viscosities between the second solution 120 and the third solution 125. For example, a viscosity range may include any viscosity from about 100 cP to 20,000 cP at room temperature, e.g. 100 cP, 500 cP, 1,000 cP, 2,500 cP, 5,000 cP, 10,000 cP, 15,000 cP, 20,000 cP, or the like. In some embodiments, the downstream viscosity range, described herein, may be located within the viscosity range of the second solution 120 and the third solution 125. Additionally or alternatively, a solid % range may include any of the solid % values between the second solution 120 and the third solution 125. For example, a solid % range may include any solid % from about 10-40 solid %, e.g., about 10-30 solid %, about 15-40 solid %, about 20-30 solid %, or the like.

In some embodiments, as shown in FIG. 2B, method 100 includes producing a range of solutions, each having a differing viscosity within the viscosity range. For example, the second solution 120 and the third solution 125 may be mixed according to a plurality of ratios, e.g., 90:10, 70:30, 50:50, 30:70, and 10:90, in which each ratio produces a distinct solution. In some embodiments, the second solution 120 may be mixed with the third solution 125 using a ratio of 90:10 to form a fourth solution 205 having a viscosity greater than the second solution 120, but lower than the first solution 105. In some embodiments, the second solution 120 may be mixed with the third solution 125 using a ratio of 70:30 to form a fifth solution 210 having a viscosity greater than the fourth solution 205, but lower than the first solution 105. In some embodiments, the second solution 120 may be mixed with the third solution 125 using a ratio of 50:50 to form the third solution 125. In some embodiments, the second solution 120 may be mixed with the third solution 125 using a ratio of 30:70 to form a sixth solution 215 having a viscosity greater than the first solution 105, but lower than the third solution 125. In some embodiments, the second solution 120 may be mixed with the third solution 125 using a ratio of 10:90 to form a seventh solution 220 having a viscosity greater than the sixth solution 215, but lower than the third solution 125.

### Arrhenius Binary Mixing Equation

In some embodiments, a method 100 of forming an aqueous polymer composition may be calculated according to Arrhenius' Logarithmic Binary Mixing Equation, Equation (1):

$$ln {μ}_{T} = {x}_{1} ln {μ}_{1} + {x}_{2} ln {μ}_{2} \qquad ( 1 )$$

wherein, x₁ is the mole fraction of a first solution, x₂ is the mole fraction of a second solution, in which x₁+x₂ is equal to 1, μ₁ is the viscosity of the first solution, μ₂ is the viscosity of the second solution, and μ_{T} is the desired downstream viscosity of the third solution when the first solution and the second solution are mixed.

In some embodiments, μ₁, μ₂, and UT are known, in which Equation 1 rearranges to Equation (2):

$${x}_{1} = \frac{( ln {μ}_{T} - ln {μ}_{2} )}{( ln {μ}_{1} - ln {μ}_{2} )} \qquad ( 2 )$$

wherein, x₂=1−x₁, and wherein the ratio of x₁ and x₂ is equal to the ratio of the first solution and the second solution to achieve the downstream viscosity ULT.

### Process Flow

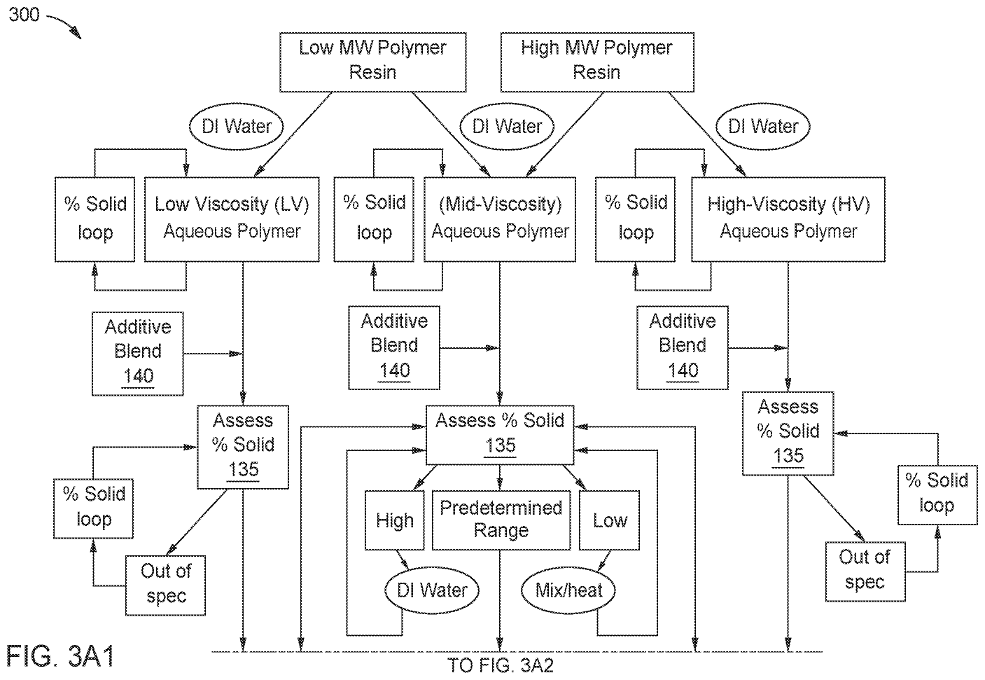

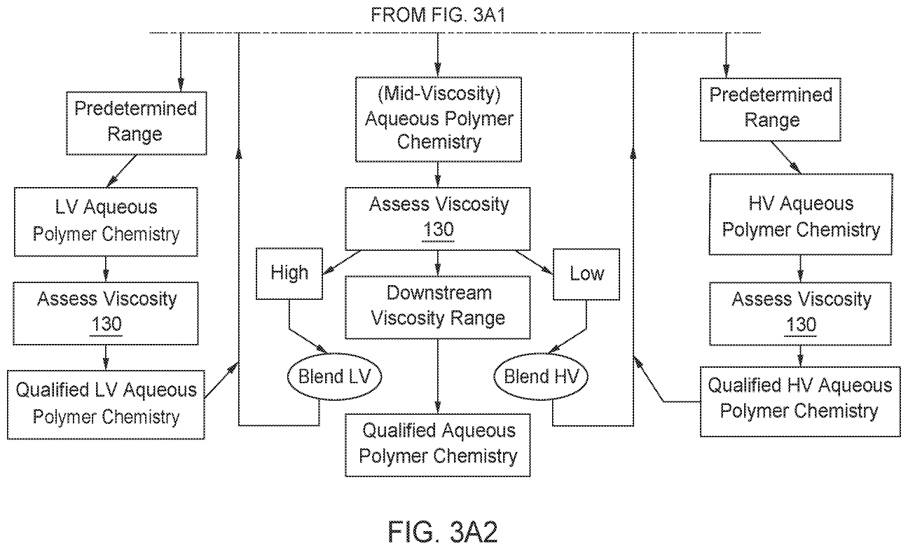

In some embodiments, and now referring to FIG. 3A, a method 300 of forming a mid-viscosity aqueous polymer composition includes forming a low-viscosity aqueous polymer solution, a mid-viscosity aqueous polymer solution, and a high-viscosity aqueous polymer solution. The low-viscosity aqueous solution may be formed by mixing a first amount of a first polymer resin in water. The high-viscosity aqueous solution may be formed by mixing a second amount of a second polymer resin in water. The mid-viscosity polymer aqueous solution may be formed by mixing a first amount of the first polymer resin dissolved in water and a second amount of the second polymer resin dissolved in water in an exploratory or predetermined ratio. Each of the low-viscosity aqueous polymer solution, mid-viscosity aqueous solution, and high-viscosity aqueous polymer solution may then be assessed for a solid percent using any of the assessment methods described herein. The solid percent of the mid-viscosity aqueous polymer solution may be adjusted, according to a first predetermined range using the first polymer resin or the second polymer resin. The solid percent of the low-viscosity aqueous polymer solution may be adjusted, according to a second predetermined range using the first polymer resin. The solid percent of the high-viscosity aqueous polymer solution may be adjusted, according to a third predetermined range using the second polymer resin.

In some embodiments, and now referring to FIG. 3B, an aqueous or otherwise chemically compatible additive solution is then mixed into each of the low-viscosity aqueous polymer solution, mid-viscosity aqueous solution, and high-viscosity aqueous polymer solution. The additive solution may include any of the additive solution described herein. The solid percent of each of the low-viscosity aqueous polymer solution, mid-viscosity aqueous solution, and high-viscosity aqueous polymer solution may then be assessed a second time.

In some embodiments, and referring again to FIG. 3A, the solid percent of the low-viscosity aqueous polymer may not be within the second predetermined range, in which a second solid percent variation is identified. The second solid percent variation denotes both the direction in which the assessed solid percent of the low-viscosity aqueous polymer solution diverges from the second predetermined range as well as the magnitude of divergence. In some embodiments, the low-viscosity range solution may be adjusted by adding the first polymer resin or water to the low-viscosity aqueous polymer, or by heating the low-viscosity aqueous polymer solution to evaporate water.

The low-viscosity aqueous polymer solution may then be assessed for a viscosity using any of the assessment methods described herein. The viscosity of the low-viscosity aqueous polymer solution may be adjusted, according to the downstream viscosity range desired by adding the first polymer resin or water to the low-viscosity aqueous polymer, or by heating the low-viscosity aqueous polymer solution to evaporate water.

In some embodiments, the solid percent of the high-viscosity aqueous polymer may not be within the third predetermined range, in which a third solid percent variation is identified. The third solid percent variation denotes both the direction in which the assessed solid percent of the high-viscosity aqueous polymer solution diverges from the third predetermined range as well as the magnitude of divergence. In some embodiments, the high-viscosity range solution may be adjusted by adding the second polymer resin or water to the high-viscosity aqueous polymer, or by heating the high-viscosity aqueous polymer solution to evaporate water.

The high-viscosity aqueous polymer solution may then be assessed for a viscosity using any of the assessment methods described herein. The viscosity of the high-viscosity aqueous polymer solution may be adjusted, according to the downstream viscosity range desired by adding the second polymer resin or water to the high-viscosity aqueous polymer, or by heating the high-viscosity aqueous polymer solution to evaporate water.

In some embodiments, when the low-viscosity aqueous polymer solution and the high-viscosity aqueous polymer solution are both within the downstream viscosity ranges, the solid percent of the mid-viscosity aqueous polymer may not be within the first predetermined range, in which a first solid percent variation is identified. The first solid percent variation denotes both the direction in which the assessed solid percent of the mid-viscosity aqueous polymer solution diverges from the first predetermined range as well as the magnitude of divergence. In some embodiments, the mid-viscosity range solution may be adjusted by adding the low-viscosity aqueous polymer solution, the high-viscosity polymer solution, heating the mid-viscosity aqueous polymer solution to evaporate water, or adding water to the mid-viscosity aqueous polymer solution to adjust a solid percent.

The mid-viscosity aqueous solution may then be assessed for a viscosity using any of the assessment methods described herein. The viscosity of the mid-viscosity aqueous polymer solution may be adjusted, according to the downstream viscosity range. For example, a viscosity that is too high may be adjusted by blending the low-viscosity aqueous polymer solution with the mid-viscosity aqueous polymer solution. As a further non-limiting example, a viscosity that is too low may be adjusted by blending the high-viscosity aqueous polymer solution with the mid-viscosity aqueous polymer solution. In some embodiments, a mid-viscosity polymer solution that has a viscosity within the downstream viscosity range may then be subject to finishing processes e.g., filtration, and then be used to coat one or more wafers or substrates.

The formation of a mid-viscosity aqueous solution having all the necessary solid percent and viscosity characteristics that are within controlled and repeatable ranges allows for a coating to be formed on a wafer or substrate that has desired and repeatable properties. As noted above, conventional polymer composition formation processes often require a large percentage of the formed polymer compositions to be formed and scraped before a polymer composition having the desired characteristics is formed due the method of formation and normal variations in the incoming polymer materials. The processes described herein may be configured to form a mid-viscosity aqueous solution that can form a thin layer polymer film that has desirable and repeatable properties. By ensuring the mid-viscosity aqueous solution exists within the viscosity downstream range and solid percent range the thin layer polymer film may be administered to the substrate to form a uniform consistent thin film polymer film. This may occur because there is no dilution of the mid-viscosity aqueous solution with water occurs. Instead, the low-viscosity or high-viscosity aqueous solution would be used to make adjustments, eliminating changes in solid percent and additive concentrations, while still allowing for changes in viscosity. For example, the mid-viscosity solution can be blended with the low-viscosity aqueous solution allowing for the additive concentration and solid percent to remain the same. Alternatively, the mid-viscosity solution can be blended with the high-viscosity aqueous solution allowing for the additive concentration and solid percent to remain the same. As such, the mid-viscosity solution may be tuned or modified without disrupting the chemistry balance of the solution. Additionally or alternatively, the tuning or targeting of the viscosity, while maintaining the solid percent, allows for variations in the incoming low-viscosity aqueous solutions or high-viscosity aqueous solutions to be accounted for and modified without adjusting the chemical concentration of solutions, e.g., reducing lot-to-lot variations or volatile contents among polymer resins obtained.

### Thin Film Polymer Coating

In an embodiment, the first solution 105 is deposited on a substrate via a spin coating or spray coating mechanism, and baked. In an embodiment, first solution 105 is baked to increase the etch resistance of the substrate by providing the etch resistant thin film polymer. In a specific embodiment, the first solution 105 is baked at a relatively high temperature approximately in the range of 50 to 130° C. In an embodiment, higher temperature baking increases etch resistance due to increased crosslinking between the first polymer resin and the second polymer resin. For example, when the first solution 105 is baked at or near 130° C. for approximately 3 minutes, the resulting etch resistant thin film polymer is robust against a silicon etch process. Specifically, E30-polyvinyl alcohol (PVA with a viscosity of approximately 1500 cP) spin-coated with oscillation at 300 rpm, cured at approximately 125° C. for 3 minutes, 60% Power, 30 kHz, 30 mm/sec, resulted in almost no consumption of the baked thin film polymer after 86 Bosch Cycles.

More generally, it is to be appreciated that a higher baking temperature corresponds to a shorter baking time and can be optimized. In one embodiment, baking is performed using a hot plate technique or a heat (light) radiation applied from the wafer front side (e.g., non-tape mounted side in the case of the use of a substrate carrier) or other suitable techniques.

In an embodiment, the etch resistant thin film polymer formed via the first solution 105 is patterned with a laser scribing process to provide an etch resistant thin film polymer with gaps exposing regions of the semiconductor wafer or substrate between integrated circuits.

In an embodiment, the thin film polymer coating may be formed according to any of the thin film polymer coating procedures described in U.S. Pat. No. 9,721,839, the entirety of which is incorporated herein. In an embodiment, the thin film polymer coating may be formed according to any of the thin film polymer coating procedures described in U.S. Patent Application Publication No. 2022/0076944 A1, the entirety of which is incorporated herein.

### Laser Etching

In an embodiment, a femtosecond-based laser is used as a source for a laser scribing process. For example, in an embodiment, a laser with a wavelength in the visible spectrum plus the ultraviolet and infrared ranges (totaling a broadband optical spectrum) is used to provide a femtosecond-based laser, e.g., a laser with a pulse width on the order of the femtosecond. In one embodiment, ablation is not, or is essentially not, wavelength dependent and is thus suitable for complex films, e.g., thin polymer films of the first solution 105 described herein.

It is to be appreciated that by using a laser beam profile with contributions from the femtosecond range, heat damage issues are mitigated or eliminated versus longer pulse widths (e.g., nanosecond processing). The elimination or mitigation of damage during laser scribing may be due to a lack of low energy recoupling or thermal equilibrium. It is also to be appreciated that laser parameter selection, such as beam profile, may be critical to developing a successful laser scribing and dicing process that minimizes chipping, micro cracks and delamination in order to achieve clean laser scribe cuts. The cleaner the laser scribe cut, the smoother an etch process that may be performed for ultimate die singulation.

In an embodiment, suitable femtosecond-based laser processes include processes having a high peak intensity (irradiance) that usually leads to nonlinear interactions in various materials. In an embodiment, the femtosecond laser sources have a pulse width approximately in the range of about 10 femtoseconds to about 500 femtoseconds, e.g., about 10 femtoseconds, about 50 femtoseconds, about 100 femtoseconds, about 150 femtoseconds, about 200 femtoseconds, about 250 femtoseconds, about 300 femtoseconds, about 350 femtoseconds, about 400 femtoseconds, about 450 femtoseconds, about 500 femtoseconds, and the like. Preferably, the femtosecond laser has a pulse width in the range of 100 femtoseconds to 400 femtoseconds. In one embodiment, the femtosecond laser sources have a wave-length approximately in the range of about 1570 nm to about 200 nm, e.g., about 1570 nm, about 1500 nm, about 1400 nm, about 1300 nm, about 1200 nm, about 1100 nm, about 1000 nm, about 900 nm, about 800 nm, about 700 nm, about 600 nm, about 500 nm, about 400 nm, about 300 nm, about 200 nm, or the like. Preferably the laser source has a wavelength in the range of 540 nanometers to 250 nanometers. In one embodiment, the laser provides a focal spot at the substrate surface in the range of about 3 microns to 15 microns, e.g., about 3 microns, about 5 microns, about 10 microns, about 15 microns, or the like. Preferably, the focal spot is in the range of about 5 microns to about 10 microns or about 10 microns to about 15 microns.

In an embodiment, the laser source has a pulse repetition rate in the range of about 200 KHz to about 10 MHZ, e.g., about 200 kHz, about 500 kHz, about 1 MHZ, about 5 MHz, about 10 MHZ, or the like. Preferably, the laser source has a pulse repetition rate of about 500 KHz to about 5 MHz. In an embodiment, the laser source delivers pulse energy at the substrate surface in the range of about 0.5 μJ to about 100 μJ, e.g., about 0.5 μJ, about 5 μJ, about 10 μJ, about 20 μJ, about 30 μJ, about 40 μJ, about 50 μJ, about 60 μJ, about 70 μJ, about 80 μJ, about 90 μJ, about 100 μJ, or the like. Preferably the laser source delivers a pulse energy in the range of about 1 μJ to about 5 μJ. In an embodiment, the laser scribing process runs along the substrate surface at a speed approximately in the range of 500 mm/sec to 5 m/sec, e.g., about 500 mm/sec, about 1 m/sec, about 2 m/sec, about 3 m/sec, about 4 m/sec, about 5 m/sec, or the like. Preferably the laser scribing is in the range of about 600 mm/sec to about 2 m/sec.

The scribing process may be run in single pass only, or in multiple passes, e.g., two passes. In one embodiment, the scribing depth in the substrate is in the range of about 5 microns to about 50 microns, e.g., about 5 microns, about 10 microns, about 15 microns, about 20 microns, about 25 microns, about 30 microns, about 35 microns, about 40 microns, about 45 microns, about 50 microns, or the like. Preferably, the scribing depth is in the range of about 10 microns to about 20 microns. In an embodiment, the kerf width of the laser beam generated is in the range of about 2 microns to about 15 microns, e.g., about 2 microns, about 4 microns, about 6 microns, about 8 microns, about 10 microns, about 12 microns, about 15 microns, or the like. Preferably, the kerf width is in the range of about 6 microns to about 10 microns.

Laser parameters may be selected with benefits and advantages such as providing sufficiently high laser intensity to achieve ionization of inorganic dielectrics (e.g., silicon dioxide) and to minimize delamination and chipping caused by under layer damage prior to direct ablation of inorganic dielectrics. Also, parameters may be selected to provide meaningful process throughput for industrial applications with precisely controlled ablation width (e.g., kerf width) and depth. In an embodiment, a line shaped profile laser beam laser scribing process is suitable to provide such advantages.

In some embodiments, the dicing or singulation process may be stopped after the above described laser scribing is used to pattern the thin film polymer and/or the substrate as well as to scribe fully through the wafer or substrate in order to singulate the dies.

In an embodiment, the laser etching may be performed according to any of the laser etching procedures described in U.S. Pat. No. 9,721,839, or U.S. Patent Application Publication No. 2022/0076944 A1, the entirety of which is incorporated herein.

### EXAMPLES

### Example 1

A first solution, with a downstream viscosity of 2,300 cP, was produced by first determining the mass of a second polymer resin, having a third solution viscosity of 2,530 cP, and a second solution having a measured viscosity of 2,150 cP and first polymer resin quantity of 4,500 g, according to Equation 2.

$${x}_{1} = \frac{( ln 2300 - ln 2530 )}{( ln 2150 - ln 2530 )}$$

$${x}_{1} = 0 \text{.5856}$$

$${x}_{2} = 1 - {x}_{1}$$

$${x}_{2} = 1 - 0 \text{.5856}$$

$${x}_{2} = 0.4144$$

wherein, the total blended mass of the first polymer resin and the second polymer resin equals the mass of the first polymer resin, 4,500 g, divided by x₂. The total blended mass equals 7,684 g, in which the required mass of the second polymer resin was 7,684 g minus 4,500 g, totaling 3,184 g.

The first solution was produced by mixing the 4,500 g of the first polymer resin and 3,184 g of the second polymer resin in water to produce a first solution having a measured viscosity of 2,330 cP, 1.3% above the calculated target of 2,300 cP, and within the error of the viscometer of record.

1. A method of forming an aqueous polymer composition, comprising:
generating a first solution by mixing a first amount of a first polymer resin and a second amount of a second polymer resin;
receiving a second solution comprising the first polymer resin, and a third solution comprising the second polymer resin;
assessing a solid percent of each of the first solution, second solution, and third solution;
assessing a viscosity of each of the first solution, second solution, and third solution; and
adjusting the viscosity of the first solution by adding an amount of the second solution or an amount of the third solution according to a desired downstream viscosity range for the first solution.

2. The method of claim 1, further comprising adjusting the solid percent of the first solution according to a first predetermined range.

3. The method of claim 2, further comprising:
comparing the assessed solid percent of the first solution to the first predetermined range;
identifying a first solid percent variation; and
adjusting the solid percent of the first solution based on the first solid percent variation.

4. The method of claim 3, herein adjusting the solid percent includes heating the first solution to evaporate water.

5. The method of claim 3, wherein adjusting the solid percent includes adding water to the first solution.

6. The method of claim 1, further comprising adjusting the solid percent of the second solution according to a second predetermined range, wherein adjusting the solid percent of the second solution is performed prior to adjusting the viscosity of the first solution.

7. The method of claim 6, further comprising;
comparing the assessed solid percent of the second solution to the second predetermined range;
identifying a second solid percent variation; and
adjusting the solid percent of the second solution based on the second solid percent variation.

8. The method of claim 1, further comprising adjusting the solid percent of the third solution according to a third predetermined range, wherein adjusting the solid percent of the third solution is performed prior to adjusting the viscosity of the first solution.

9. The method of claim 8, further comprising;
comparing the assessed solid percent of the third solution to the third predetermined range;
identifying a third solid percent variation; and
adjusting the solid percent of the third solution based on the third solid percent variation.

10. The method of claim 1, further comprising mixing an additive solution with the first solution, the second solution, and the third solution.

11. The method of claim 1, wherein the first polymer resin is a first water-soluble polymer.

12. The method of claim 11, wherein the first water soluble polymer is selected from poly(vinyl alcohol), poly(acrylic acid), poly(methacrylic acid), poly(acrylamide) and poly(ethylene oxide).

13. The method of claim 1, wherein the second polymer resin is a second water-soluble polymer.

14. The method of claim 13, wherein the second water soluble polymer is selected from poly(vinyl alcohol), poly(acrylic acid), poly(methacrylic acid), poly(acrylamide) and poly(ethylene oxide).

15. A method of forming an aqueous polymer composition, comprising:
generating a first solution by mixing a first amount of a first polymer resin and a second amount of a second polymer resin;
receiving a second solution comprising the first polymer resin, wherein the second solution has a solid percent of about 10% to about 40% and a viscosity of about 100 cP to about 2,300 cP;
receiving a third solution comprising the second polymer resin, wherein the third solution has a solid percent of about 10% to about 40% and a viscosity of about 2,300 cP to about 2,700 cP;
assessing a solid percent of the first solution;
adjusting the solid percent of the first solution according to a first predetermined range using the second solution or the third solution;
assessing a viscosity of the first solution;
adjusting the viscosity of the first solution according to a desired downstream viscosity range using the second solution or the third solution; and
depositing the first solution on a substrate.

16. The method of claim 15, further comprising adjusting the solid percent of the second solution according to a second predetermined range, wherein adjusting the solid percent of the second solution is performed prior to adjusting the viscosity of the first solution.

17. The method of claim 16, further comprising;
comparing the assessed solid percent of the second solution to the second predetermined range;
identifying a second solid percent variation; and
adjusting the solid percent of the second solution based on the second solid percent variation.

18. The method of claim 15, further comprising adjusting the solid percent of the third solution according to a third predetermined range, wherein adjusting the solid percent of the third solution is performed prior to adjusting the viscosity of the first solution.

19. The method of claim 18, further comprising;
comparing the assessed solid percent of the third solution to the third predetermined range;
identifying a third solid percent variation; and
adjusting the solid percent of the third solution based on the third solid percent variation.

20. The method of claim 15, further comprising mixing an additive solution with the first solution, the second solution, and the third solution.
